(19) United States
(12) Patent Application Publication
(10) Pub. No.: US 2023/0146184 A1
(43) Pub. Date: May 11, 2023

(54) LOW ENERGY MOTORIZED PLATFORM COMPRISING SOLAR PANELS

(71) Applicant: Johnathan McCutcheon, Houston, TX (US)

(72) Inventor: Johnathan McCutcheon, Houston, TX (US)

(21) Appl. No.: 17/522,738

(22) Filed: Nov. 9, 2021

(51) Int. Cl. H02S 20/32; H02S 50/00

(52) U.S. Cl. CPC H02S 20/32; H02S 50/00

(57) ABSTRACT

A motorized platform comprising one or more rails of solar panels is disclosed. The motorized platform includes one or more solar panel support devices. The solar panel support devices include a solar panel base configured to support one or more solar panels. The solar panel support devices include a compression ball joint connected to the solar panel base comprising axial rotational movement. The solar panel support devices include a plurality of wire rods configured to provide tension to the solar panel base. The motorized platform also includes one or more motors and springs.

### FIELD OF THE INVENTION

This disclosure relates to a solar panel platform. Specifically, this disclosure relates to a device for a low energy motorized platform comprising a plurality of solar panels.

### BACKGROUND

A variety of system have been used in order to mount and direct a plurality of solar panels, electric generating modules, arrays and associated components of electric power generating systems onto the roofs of buildings. The positioning of these solar panels and electric generating modules are important in order to capture as much sunlight as possible in order to store enough energy generated by the solar panels into electric storage devices. Based on the location of the solar panels, solar panels can individually or in combination receive a maximum volume percentage of electric power that can then be utilized by the building structure as natural generated power.

However, the current systems do not teach a mechanically simple or time and cost-effective method to effectively adjust the angle of elevation of a group of solar panels groups or assembles of solar panels after mounting to the roof. Such adjustment of the angle of elevation, or the position, relative to the plane of a roof is frequently necessitated for any number of reasons inclusive of standard maintenance of the roof, protection of the solar panels in the event of a storm condition, and most importantly optimizing the quantity of energy received from the sun, as a function of both geographic latitude of the installation and particular time of the year.

While the mounting of solar panels on a roof or physical structure is commonly used in installation practices, there is a lack of strategy to sufficiently address the issue of maximizing the amount of sunlight received for electric storage through the optimization of the angle of elevation of a solar panel group and the need to be able to quickly and cost-effectively change this angle responsive to various factors as above set forth.

The instant invention addresses the above long-felt needs for such a method and system to selectively adjust a plurality of solar panels in order to ensure that the maximum storage of electricity from sun light is attainable.

Accordingly, embodiments of the invention, provide significant advantages while overcoming the above-described and other disadvantages, as will now be described.

### SUMMARY

A motorized platform comprising one or more rails of solar panels is disclosed. The motorized platform includes one or more solar panel support devices. The solar panel support devices include a solar panel base configured to support one or more solar panels. The solar panel support devices include a compression ball joint connected to the solar panel base comprising axial rotational movement. The solar panel support devices include a plurality of wire rods configured to provide tension to the solar panel base. The solar panel support devices include a ball joint base comprising a pillar attached to the compression ball joint. The solar panel support devices include a set of spooling devices configured to maintain the tension of the one or more wire rods relative to the solar panel connected to the solar panel base. The motorized platform also includes one or more motors and springs. The motors and springs include a first motor configured to attach to a first wire resulting in the solar panels being configured to move on the y-axis of the compressional ball joint. The motors and springs include a first spring configured to attach to a second wire maintaining the opposite tension of the first wire. The motors and springs include a second motor configured to attach to a third wire resulting in the solar panels being configured to move on the x-axis of the compressional ball joint. The motors and springs include a second spring configured to attach to a fourth wire maintaining the opposite tension of the first wire.

In one embodiment, the compression ball joint is configured to rotate in the y-axis direction at the x-axis direction corresponding to movement of the sun.

In one embodiment, the plurality of wires is secured to a sliding block positioned in grooves in the solar panel base, wherein the groove are configured to allow the sliding blocks to slide in a forward and backward direction.

In one embodiment, the plurality of wires is secured to the sliding block with a screw configured to increase or decrease the tension of the secured wire.

In one embodiment, the motorized platform further includes a photometer configured to measure the intensity of the sun at predetermined periods. The motorized platform also includes a controller to activate the one or more motors in order to rotate the solar panel base in an x-axis direction and a y-axis direction based on a determined maximum intensity.

In one embodiment, the one or more motors can orientate the panels and change the pitch angle relative to the orientation of the sun based on the determined maximum intensity.

In one embodiment, the one or more rails are configured to be secured to a fixed structure, a roof, or a ground mounting system.

In one embodiment, the one or more rails are positioned individually.

In one embodiment, the one or more rails are positioned in tandem.

This summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of low energy motorized platform of solar panels. This description includes drawings, wherein:

FIG. 1 depicts a biotensegrity model of the motorized platform of solar panels, in accordance with an example;

FIG. 2 depicts a diagram of daytime movement of the motorized platform of solar panels, in accordance with an example;

FIG. 3 depicts a diagram of precession movement of the motorized platform of solar panels, in accordance with an example;

FIG. 4 depicts an example operation of the motorized platform of solar panels, in accordance with an example;

FIG. 5 depicts an example operation of precession movement of the motorized platform of solar panels, in accordance with a example;

FIG. 6 depicts a mechanism to regulate tension of the wire rod, in accordance with a example;

FIG. 7 depicts a perspective view of the motors and the actuator arms, in accordance with an example;

FIG. 8 depicts a plurality of solar panels in a rack, in accordance with an example; and

FIG. 9 depicts a plurality of solar panels positioned in tandem, in accordance with an example.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The preferred embodiment herein described is not intended to be exhaustive or to limit the invention to the precise form disclosed. It is chosen and described to explain the principles of the invention and its application and practical use to enable others skilled in the art to follow its teachings.

Accordingly, a motorized platform comprising one or more rails of solar panels is disclosed. The motorized platform includes one or more solar panel support devices. The solar panel support devices include a solar panel base configured to support one or more solar panels. The solar panel support devices include a compression ball joint connected to the solar panel base comprising axial rotational movement. The solar panel support devices include a plurality of wire rods configured to provide tension to the solar panel base. The solar panel support devices include a ball joint base comprising a pillar attached to the compression ball joint. The solar panel support devices include a set of spooling devices configured to maintain the tension of the one or more wire rods relative to the solar panel connected to the solar panel base. The motorized platform also includes one or more motors and springs. The motors and springs include a first motor configured to attach to a first wire resulting in the solar panels being configured to move on the y-axis of the compressional ball joint. The motors and springs include a first spring configured to attach to a second wire maintaining the opposite tension of the first wire. The motors and springs include a second motor configured to attach to a third wire resulting in the solar panels being configured to move on the x-axis of the compressional ball joint. The motors and springs include a second spring configured to attach to a fourth wire maintaining the opposite tension of the first wire.

The current invention is directed towards creating a low energy motorized platform that utilizes Tensegrity to move a rail or rails of solar panel at the same time. This can be created by using low friction, high efficiency single point tension movements on one or more cable lines in order to orientate a plurality of solar panels to their maximum efficiency angles relative to the sun, configured by a photometer.

The described embodiments hereinafter are intended for a plurality of uses and installation. For example, the described embodiments can be intended for 180-degree installations, ground mounts with optimal access to sun exposure, flat roofs and commercial/industrial buildings. Accordingly, a rail system comprising one or more rails or a plurality of rails could be placed along the installation structures in order to facilitate the control of the pitch or angle of orientation of the suspended panels using a photometer to achieve maximum energy production. This can all be completed while utilizing the smallest amount of movement or energy consumption by the motorized system as possible.

Accordingly, advantages of the design allow the orientation of many panels to be quickly altered so as to efficiently maximize those panels' energy production. The maximization of these panels can be completed while utilizing less energy and thus further optimizing the energy produced and net energy gains of the panels themselves.

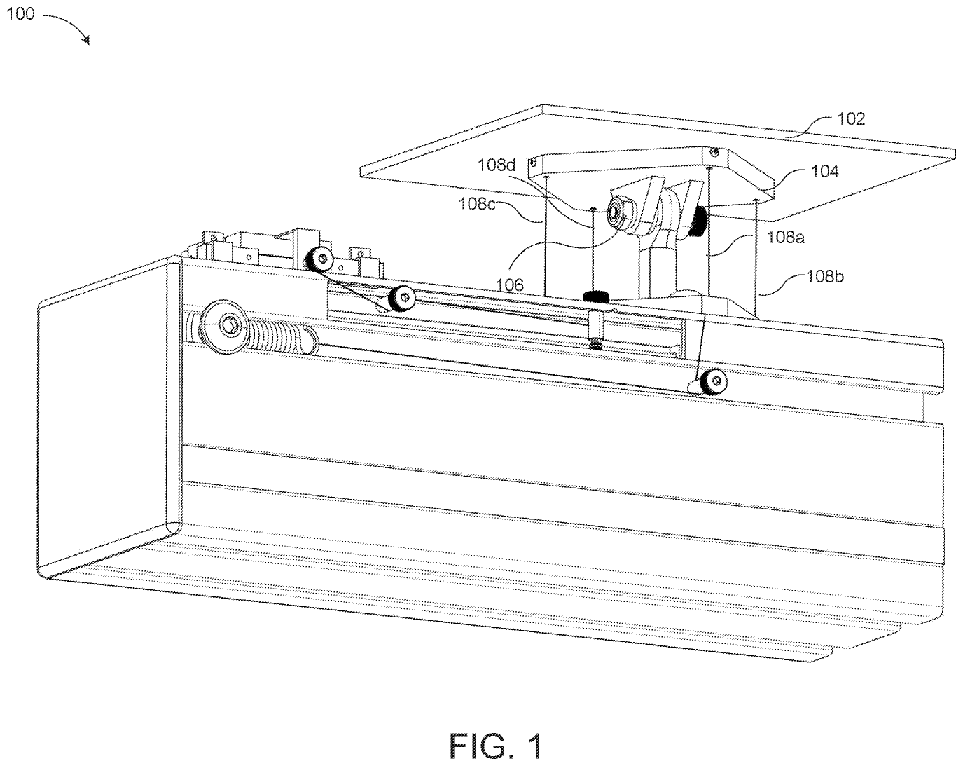

FIG. 1 depicts a biotensegrity model of the motorized platform 100 of solar panels. The solar panel 102 is configured to be positioned in a direction that would facilitate the most sunlight exposure. The solar panel 102 is configured to be connected to a ball joint base 104 comprising a pillar attached to the compression ball joint 106. The compression ball joint 106 is configured to allow the solar panel to rotate on a 360 degree axis. In order to accurate control the angle of direction the solar panel is directed towards in relevance to the sun's position in the sky, a plurality of wire rods 108a-d can be utilized in order to control the overall tension at multiple points of the ball joint base 104. Each of the wire rods are configured to help facilitate the movement of the solar panel's 102 axial rotation about the ball joint 106.

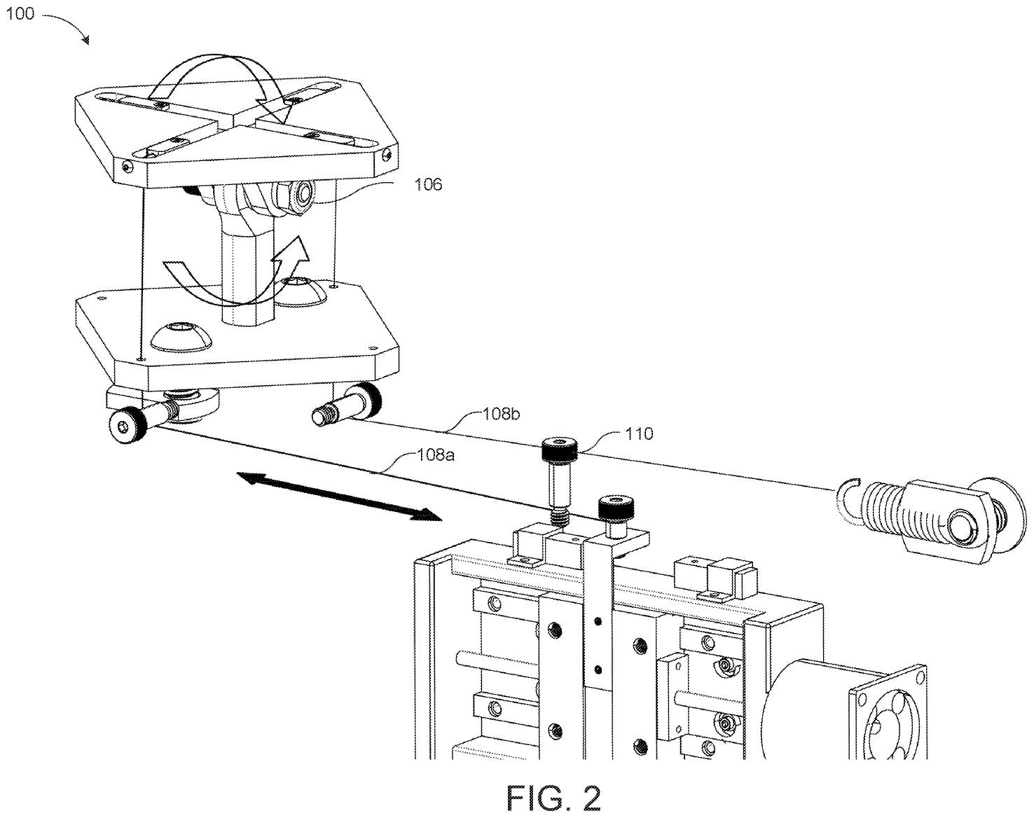

FIG. 2 depicts a diagram of daytime movement of the motorized platform 100 of solar panels. Based on the movement of the sun, the solar panels 102 movement can perform a rotation, or an angle adjustment about the axial rotational area of the ball joint 106. The ball joint 106 is configured to have no limit in axial rotation to the ball axis, about the y-axis. The lack of limitation to rotate about the ball axis allows a great degree of freedom to follow the daytime movement of the sun.

Accordingly, a motor 110, can be utilized to move one or more of the wire rods 108a that are configured to rotate the ball joint 106 on the y-axis. In association with a first wire rod 108a, a second wire rod 108b is configured to be attached to a traction spring 112. The traction spring 112 is configured to maintain an opposite tension from the first wire rod 108 attached to the motor 110. This allows for the combination of both the first wire rod 108a and the second wire rod 108b to provide stability along the y-axis of the ball joint 106 associated with the solar panel 102 angle of direction.

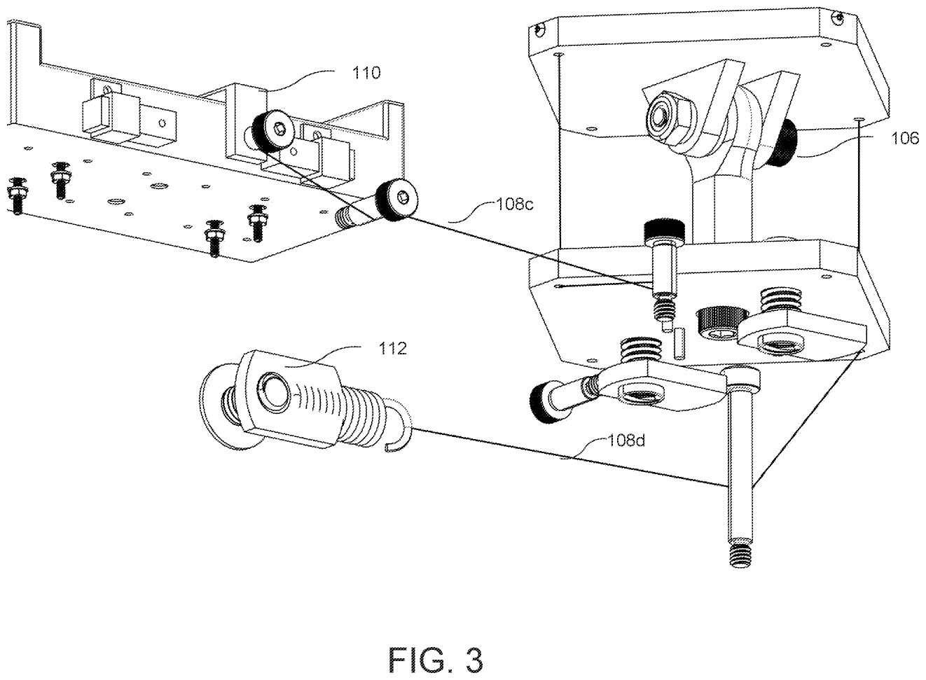

FIG. 3 depicts a diagram of precession movement of the motorized platform of solar panels. Similar to the disclosure of FIG. 2, the ball joint 106 can also allow for limited rotation along the x-axis, associated with the angle of direction of the solar panel. Accordingly, a motor 110, is configured to move a third wire rod 108c to rotate the ball joint 106 along the x axis. Similarly, a fourth wire rod 108d is configured to be attached to a second traction spring 112. The second traction spring 112 is configured to maintain tension of the fourth wire rod 108d, opposite from the third wire rod 108c in order to achieve stability along the x-axis. The combination of all of the components described above and embodiments thereof form a solar panel assembly that is configured to be positioned on a rail system.

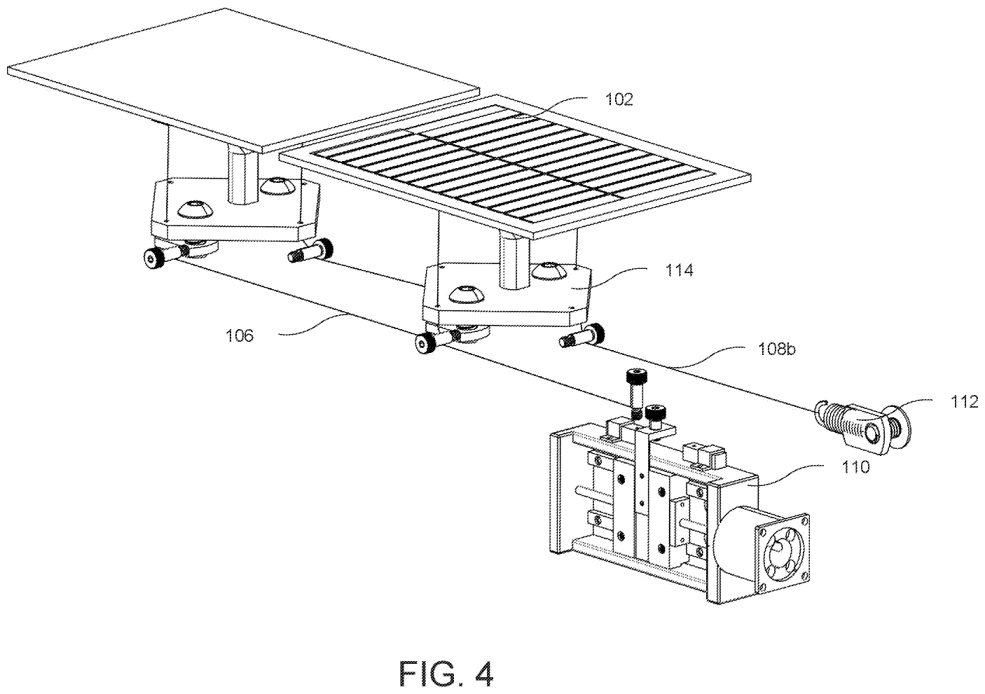

FIG. 4 depicts an example operation of the motorized platform of solar panels. Accordingly, the plurality of solar panel assemblies 400 are configured to be positioned on a rail device 114 that allows for rotational and directional movement of a plurality of solar panels 102 relative to the movement of the sun, as measured by a photometer. As the photometer measures the maximum sun intensity coming from the sun's current and constantly moving position during the daytime, the solar panels 102 can be moved by one or more motors along an x and y axial direction, as well as in a directional position along the rail device 114. Accordingly, a single motor is configured to be attached to the first wire rod 108a in order to move all the solar panels on the same rack along the y axis. Accordingly, a single spring 112 can be attached to the second wire rod 108b in order to keep all of the panels stable along the y-axis in accordance with an embodiment of the above-described embodiment.

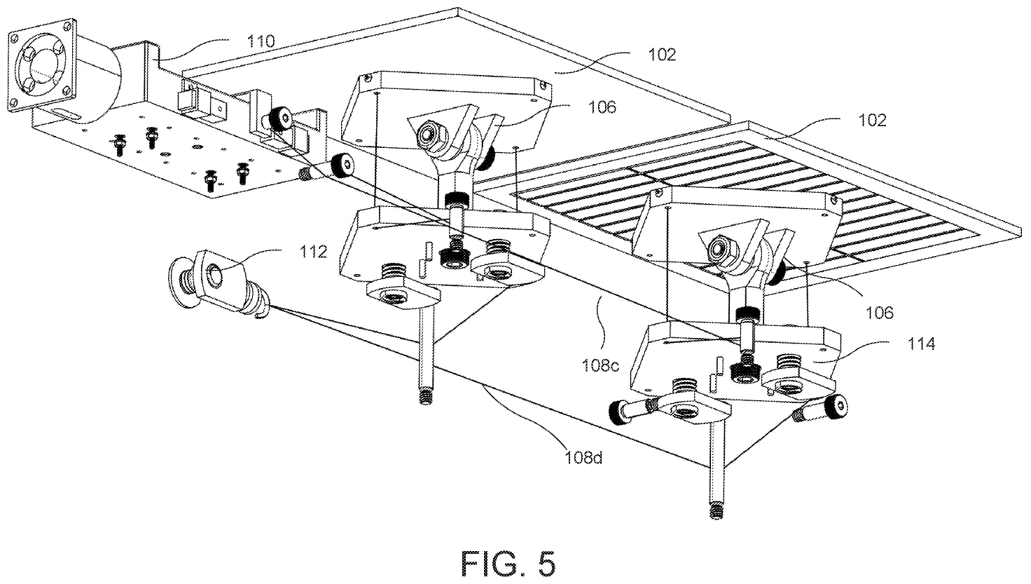

FIG. 5 depicts an example operation of precession movement of the motorized platform of solar panels. Accordingly, the solar panel assemblies 400 positioned on the rail device 114 can be assembled in furtherance in the embodiments described in FIG. 5. The third wire rod 108c can be configured to be attached to a single motor 110 that is configured to move all of the plurality of solar panels 110 on the same rail device 114 along the x-axis relative to the ball joints 106 of the plurality of solar panels 102. A spring is configured to be attached to the fourth wire rod 108d in order to keep all of the solar panels 102 stable along the x axis.

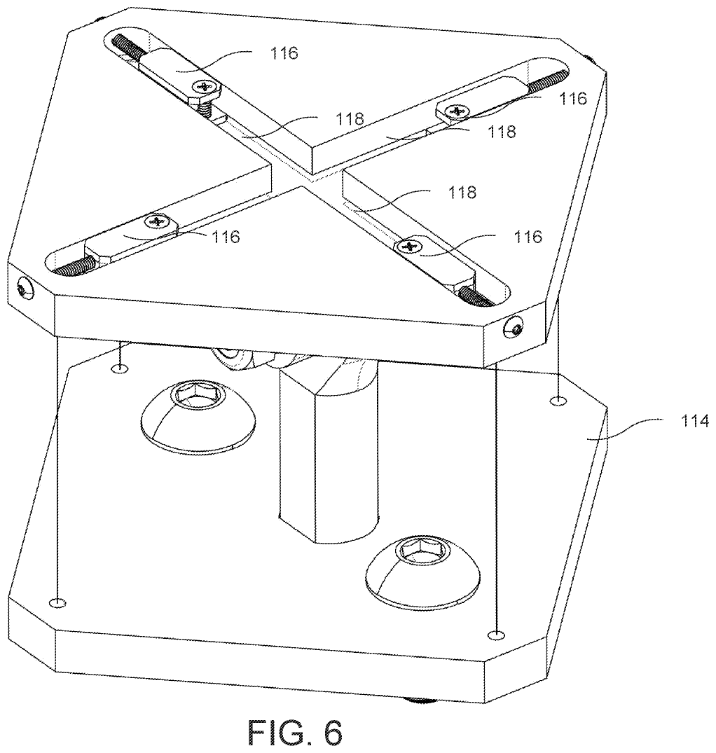

FIG. 6 depicts a mechanism 600 to regulate tension of the wire rod. In order to regulate the tension of each of the wire rods 108a-d, one or more sliding blocks 116 can be positioned in one or more grooves 118 relative to the position of the wire rods 108a-d. Accordingly, there can be a sliding block 116 assigned and connected to each of the wire rods 108a-d. The sliding blocks 116 are configured to slide along the groove 118 and positioned in accordance with an optimal predetermined tension needed in order to provide stability when rotated about the axial rotation of the ball joint 106 in the x-axis direction or the y-axis direction. In order to secure the blocks 116 in the grooves 118, the one or more screws can be inserted through the solar panel base 104 securing the blocks 116 to the solar panel base 104. Additionally, one or more screws can also be utilized to secure each of the wire rods 108a-d to the blocks in order to ensure that tension is secured to the solar panel base 104.

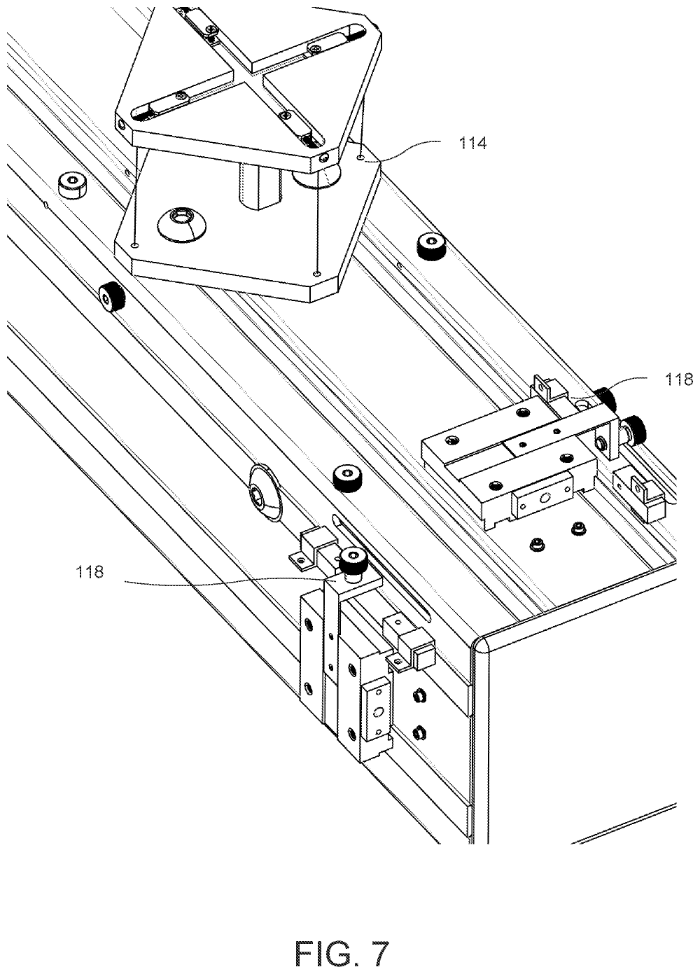

FIG. 7 depicts a perspective view of the motors and the actuator arms. The motors 110 are configured to be connected to one or more actuator arms 118. The actuator arms are configured to position the motors 110 along the rail device 114 in order to ensure the proper tension to cause movement of the wire rods 108a-d while facilitating the movement of the solar panel base 104 connected to the solar panel 102.

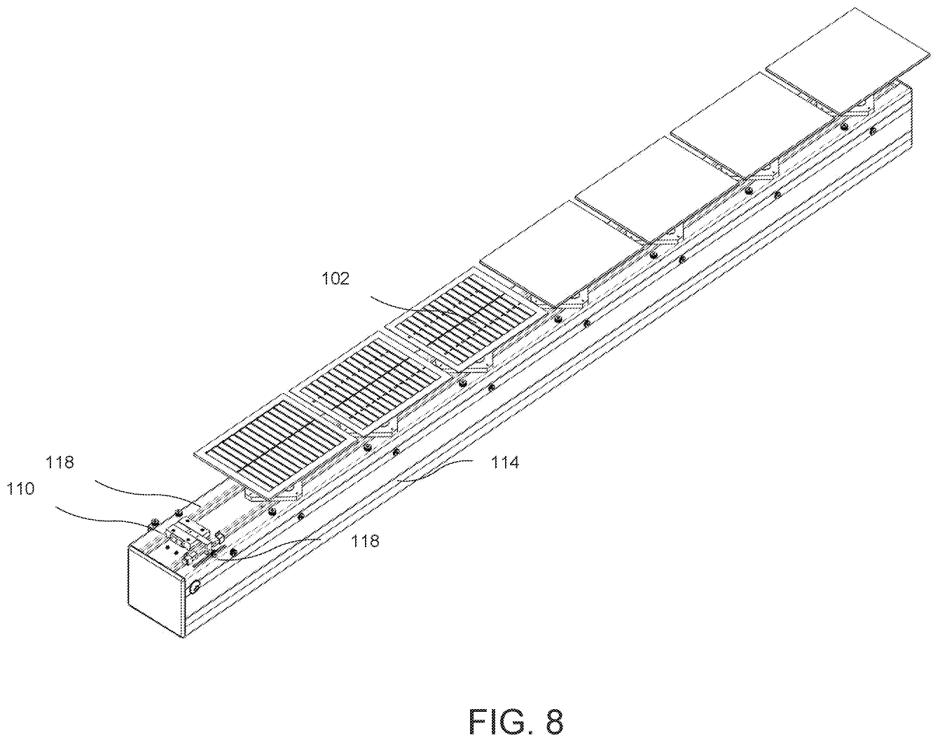

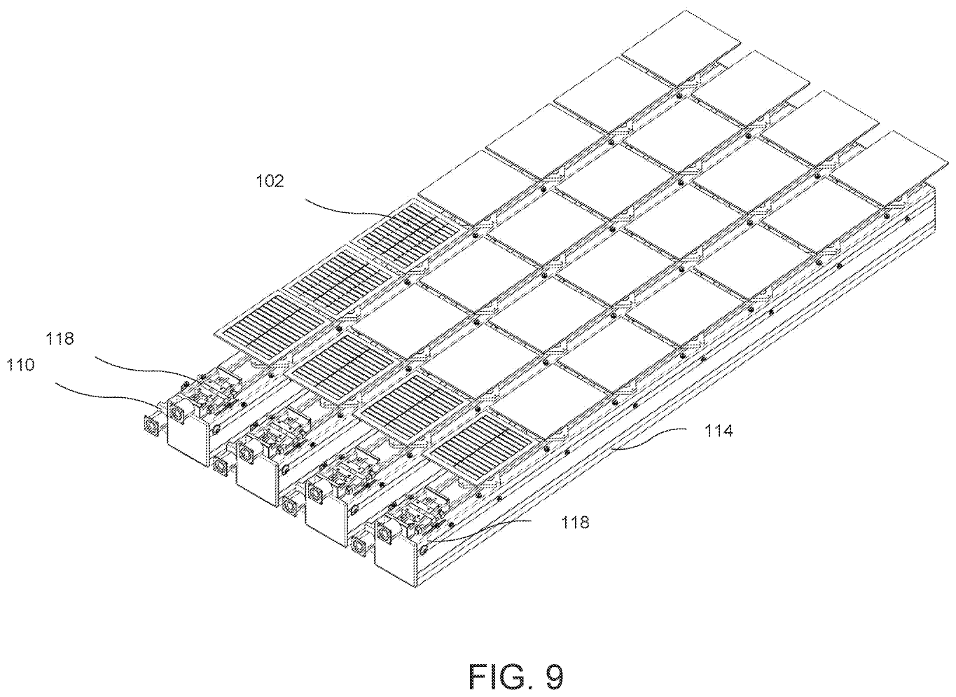

FIG. 8 depicts a plurality of solar panels in a rack. The motors 110 and the actuator arms 118 are positioned at one end of the rail device 114 and attached to the wire rods 108a-d in series, allowing for simultaneous movement of each of the plurality of solar panels 102. The maximum number of solar panels 102 that are assembled in the rail device 114 is determined based on the strength of the motors 110 itself. The stronger the motors 110, the more solar panels that can be assembled in the rail device 114. Additionally, multiple rail devices 114 can be assembled as arrays in tandem format as shown in FIG. 9.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

Although the present invention has been described in terms of various embodiments, it is not intended that the invention be limited to these embodiments. Modification within the spirit of the invention will be apparent to those skilled in the art.

It is additionally noted and anticipated that although the device is shown in its most simple form, various components and aspects of the device may be differently shaped or modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A motorized platform comprising one or more rails of solar panels, the platform comprising:
one or more solar panel support devices comprising:
a solar panel base configured to support one or more solar panels;
a compression ball joint connected to the solar panel base comprising axial rotational movement;
a plurality of wire rods configured to provide tension to the solar panel base;
a ball joint base comprising a pillar attached to the compression ball joint;
a set of spooling devices configured to maintain the tension of the one or more wire rods relative to the solar panel connected to the solar panel base; and
one or more motors and springs comprising:
a first motor configured to attach to a first wire resulting in the solar panels being configured to move on the y-axis of the compressional ball joint;
a first spring configured to attach to a second wire maintaining the opposite tension of the first wire;
a second motor configured to attach to a third wire resulting in the solar panels being configured to move on the x-axis of the compressional ball joint;
a second spring configured to attach to a fourth wire maintaining the opposite tension of the first wire.

2. The platform of claim 1, wherein the compression ball joint is configured to rotate in the y-axis direction at the x-axis direction corresponding to movement of the sun.

3. The platform of claim 1, wherein the plurality of wires is secured to a sliding block positioned in grooves in the solar panel base, wherein the groove are configured to allow the sliding blocks to slide in a forward and backward direction.

4. The platform of claim 1, wherein the plurality of wires is secured to the sliding block with a screw configured to increase or decrease the tension of the secured wire.

5. The platform of claim 1, further comprising:
a photometer configured to measure the intensity of the sun at predetermined periods; and
a controller to activate the one or more motors in order to rotate the solar panel base in an x-axis direction and a y-axis direction based on a determined maximum intensity.

6. The platform of claim 5, wherein the one or more motors can orientate the panels and change the pitch angle relative to the orientation of the sun based on the determined maximum intensity.

7. The platform of claim 1, wherein the one or more rails are configured to be secured to a fixed structure, a roof, or a ground mounting system.

8. The platform of claim 1, wherein the one or more rails are positioned individually.

9. The platform of claim 1, wherein the one or more rails are positioned in tandem.
